(19) United States
(12) Patent Application Publication
(10) Pub. No.: US 2026/0140637 A1
(43) Pub. Date: May 21, 2026

(54) STORAGE DEVICE, STORAGE SYSTEM AND OPERATING METHOD THEREOF

(71) Applicant: SAMSUNG ELECTRONICS CO., LTD., Suwon-si (KR)

(72) Inventors: Yongseok WON, Suwon-si (KR); Seungkyu HONG, Suwon-si (KR); Dokyung JEONG, Suwon-si (KR)

(73) Assignee: SAMSUNG ELECTRONICS CO., LTD., Suwon-si (KR)

(21) Appl. No.: 19/253,050

(22) Filed: Jun. 27, 2025

(30) Foreign Application Priority Data
Nov. 19, 2024 (KR) 10-2024-0165714

(51) Int. Cl. G06F 3/06

(52) U.S. Cl. CPC G06F 3/0619; G06F 3/0631; G06F 3/067; G06F 3/0688

(57) ABSTRACT

A storage device includes: a plurality of non-volatile memories comprising a plurality of super blocks, each of which comprises a plurality of memory blocks on a plurality of dies, and a storage controller configured to: allocate a plurality of name spaces to a plurality of tenants, determine grades of the plurality of super blocks, based on a remapping count of remapping one memory block to another memory block in each of the plurality of super blocks, and an erase count of an erase operation with respect to the plurality of memory blocks, and allocate the plurality of super blocks to the plurality of name spaces, based on the grades of the plurality of super blocks and priority information about the plurality of tenants.

### CROSS-REFERENCE TO RELATED APPLICATION

This application is based on and claims priority under 35 U.S.C. § 119 to Korean Patent Application No. 10-2024-0165714, filed on Nov. 19, 2024, in the Korean Intellectual Property Office, the disclosure of which is incorporated by reference herein in its entirety.

### BACKGROUND

The present disclosure relates to a storage device, a storage system, and a method of operating the same.

In recent years, with the advancement of semiconductor technology, the performance of computer processors has greatly improved. With the development of multi-core processor technology, the amount of work that may be done simultaneously on a single computer server has increased significantly.

Accordingly, data centers install hundreds or thousands of computer servers in one location to provide diverse and stable services (e.g., web servers, mail servers, file servers, video servers, cloud servers) to different service users.

In order to satisfy the Quality of Service (QoS) provided to tenants requesting connection to the data center, storage devices that support ‘namespace’ function are used to enable efficient use of storage devices.

### SUMMARY

Provided are a storage device, a storage system, and operating methods of the storage device and the storage system, which are capable of efficiently managing memory resources.

Provided are a storage device, a storage system, and operating methods of the storage device and the storage system, which equally or differentially distributes QoS of a service provided to multiple tenants.

According to an aspect of the disclosure, a storage device includes: a plurality of non-volatile memories comprising a plurality of super blocks, each of which comprises a plurality of memory blocks on a plurality of dies, and a storage controller configured to: allocate a plurality of name spaces to a plurality of tenants, determine grades of the plurality of super blocks, based on a remapping count of remapping one memory block to another memory block in each of the plurality of super blocks, and an erase count of an erase operation with respect to the plurality of memory blocks, and allocate the plurality of super blocks to the plurality of name spaces, based on the grades of the plurality of super blocks and priority information about the plurality of tenants.

According to an aspect of the disclosure, a storage system includes: a host device configured to manage a plurality of tenants and provide priority information of the plurality of tenants, and a storage device configured to: determine grades of a plurality of super blocks, based on a plurality of parameters of memory blocks in a plurality of super blocks, and allocate the plurality of super blocks to a plurality of name spaces allocated to the plurality of tenants, based on the grades of the plurality of super blocks and based on the priority information.

According to an aspect of the disclosure, a method of operating a storage device, includes: assigning a plurality of name spaces to a plurality of tenants, respectively; determining grades of a plurality of super blocks based on a remapping count in which one of memory blocks included in each of the plurality of super blocks including the plurality of memory blocks on a plurality of dies is mapped to another memory block and an erase count of an erase operation with respect to the plurality of memory blocks; and allocating the plurality of super blocks to the plurality of name spaces based on ranks of the plurality of super blocks and priority information about the plurality of tenants.

### BRIEF DESCRIPTION OF DRAWINGS

The above and other aspects, features, and advantages of certain embodiments of the disclosure will be more apparent from the following description taken in conjunction with the accompanying drawings, in which:

FIG. 1 illustrates a storage system according to one embodiment;

FIG. 2 illustrates a process in which a host device recognizes a physical space according to one embodiment;

FIG. 3 illustrates an example of multiple name spaces allocated to multiple non-volatile memories according to one embodiment;

FIG. 4 illustrates an example of multiple name spaces allocated to multiple non-volatile memories according to one embodiment;

FIG. 5 illustrates a process in which a host device recognizes a physical space according to one embodiment;

FIG. 6 illustrates an example of multiple name spaces allocated to multiple non-volatile memories according to one embodiment;

FIG. 7 illustrates an example of a storage controller included in a storage device according to one embodiment;

FIG. 8 illustrates an example of a nonvolatile memory according to one embodiment;

FIG. 9 illustrates an example of the number of blocks according to one embodiment;

FIG. 10 illustrates a plurality of super blocks each including a plurality of virtual functions and a plurality of name spaces each associated with a plurality of virtual functions according to one embodiment;

FIG. 11 illustrates a grade hash table according to one embodiment;

FIGS. 12 and 13 illustrate counting of the number of global remapping count of a super block;

FIG. 14 is a graph showing the delay time occurring in multiple virtual functions;

FIG. 15 illustrates a plurality of super blocks each including a plurality of virtual functions and a plurality of name spaces each associated with a plurality of virtual functions according to one embodiment;

FIG. 16 is a graph showing the delay time occurring in multiple virtual functions;

FIG. 17 illustrates a plurality of super blocks each including a plurality of virtual functions and a plurality of name spaces each associated with a plurality of virtual functions according to one embodiment.

FIG. 18 illustrates a plurality of super blocks equally allocated to a plurality of virtual functions and a plurality of name spaces each associated with a plurality of virtual functions according to one embodiment;

FIG. 19 illustrates a plurality of super blocks each including a plurality of virtual functions and a plurality of name spaces each associated with the same, according to one embodiment;

FIG. 20 illustrates a plurality of super blocks, each of which includes a plurality of virtual functions and a plurality of name spaces, each of which is associated with a plurality of virtual functions, allocated unevenly according to one embodiment;

FIG. 21 illustrates a process in which a storage device provides multiple super blocks to multiple tenants;

FIG. 22 illustrates the process by which a storage device determines the grade of a super block; and

FIG. 23 illustrates a computer device according to one embodiment.

### DETAILED DESCRIPTION

Below, with reference to the attached drawings, embodiments of the present disclosure are described in detail so that a person having ordinary skill in the art to which the present disclosure pertains may easily practice the present disclosure. However, the present disclosure may be implemented in various different forms and is not limited to the embodiments described herein.

Accordingly, the drawings and description are to be regarded as illustrative in nature and not restrictive. Like reference numerals designate like elements throughout the specification. And in order to clearly explain the present disclosure in the drawings, parts unrelated to the explanation are omitted, and similar parts are given similar drawing reference numerals throughout the specification.

In the flowchart described with reference to the drawings, the order of operations may be changed, several operations may be merged, some operations may be split, and certain operations may not be performed. Additionally, expressions written in the singular may be interpreted as singular or plural, unless explicit expressions such as \“one\” or \“singular\” are used.

Terms that include ordinal numbers, such as first, second, etc., may be used to describe various components, but the components are not limited by these terms. These terms may be used to distinguish one component from another.

Hereinafter, the present disclosure will be described in more detail through examples. These examples are intended only to illustrate the present disclosure, and the scope of protection of the rights of the present disclosure is not limited by these examples.

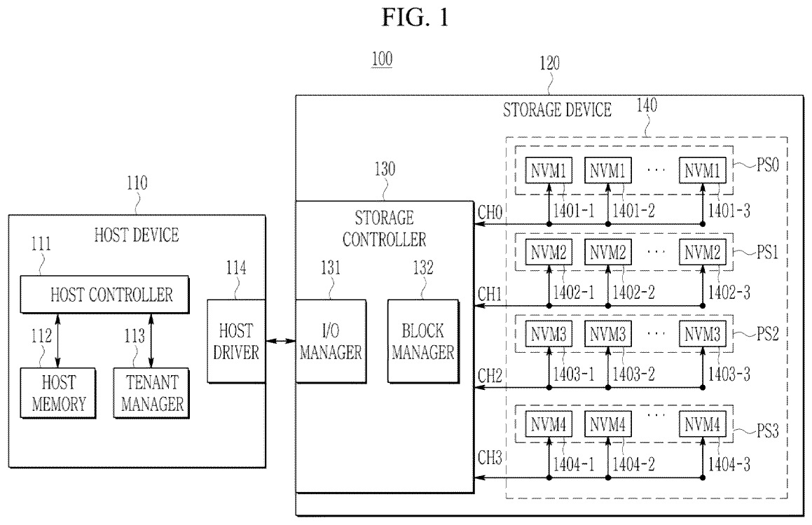

FIG. 1 illustrates a storage system according to one embodiment.

Referring to FIG. 1, a storage system (100) may include a host device (110) and a storage device (120).

The host device (110) may be configured to control the overall operation of the storage system (100). The host device (110) may include a host controller (111), host memory (112), a tenant manager (113), and a host driver (114).

The host controller (111) may be configured to control the operation of the host device (110) and may run an operating system (OS). The operating system executed by the host controller (111) may include a file system for file management. Host memory (112) may store instructions and data executed and processed by the host controller (111).

A tenant manager (113) may be configured to store and modify information about multiple tenants managed by a host device (110). For example, information about multiple tenants may include information about an identification (ID) assigned to each of the multiple tenants and a priority of each of the multiple tenants.

The tenant manager (113) may be configured to identify the tenant to which the user who requested the task from the host device (110) belongs. For example, when multiple users each request a task, the tenant manager (113) may transmit information about the ID and priority of the tenant corresponding to each of the multiple users to the storage device (120).

The host driver (114) may be configured to control peripheral devices including storage devices (120) at the operating system level of the host device (110). The host driver (114) may transmit instructions and data executed and processed by the host controller (111) to the storage device (120).

The host device (110) may be configured to communicate with the storage device (120) through an interface. For example, the host device (110) may communicate with the storage device (120) through an interface such as USB (Universal Serial Bus), MMC (MultiMediaCard), PCI-e (PCIexpress), ATA (AT Attachment), SATA (Serial AT Attachment), PATA (Parallel AT Attachment), SCSI (Small Computer System Interface), SAS (Serial Attached SCSI), ESDI (Enhanced Small Disk Interface), IDE (Integrated Drive Electronics), NVMe (Non-Volatile Memory Express), etc.

The storage device (120) may be accessed by the host device (110). The storage device (120) may include a storage controller (130) and a non-volatile memory device (140).

The storage controller (130) may be configured to process various requests from the host device (110). For example, the storage controller (130) may store data in a nonvolatile memory device (140) or read stored data at the request of the host device (110). The storage controller (130) may be an NVMe controller based on an NVMe (Nonvolatile Memory express) interface.

The host device (110) may recognize the storage space of the storage device (120) as physically separated areas (e.g., physical space). For example, the host device (110) may recognize the storage space of the storage device (120) as the first physical space to the fourth physical space (PS0 to PS3). The host device (110) may individually or independently control each of the first to fourth physically separated physical spaces (PS0 to PS3). The number of physical spaces (PS0 to PS3) is not limited to the above embodiment.

The storage controller (130) may communicate with the first physical space to the fourth physical space (PS0 to PS3) through multiple channels (CH0 to CH3). For example, the storage controller (130) may communicate with the first physical space (PS0) through the first channel (CH0) and communicate with the second physical space (PS1) through the second channel (CH1). The storage controller (130) may communicate with the third physical space (PS2) through the third channel (CH2) and with the fourth physical space (PS3) through the fourth channel (CH3). That is, each of the multiple channels (CH0 to CH3) may be connected to the first physical space to the fourth physical space (PS0 to PS3), respectively. The scope of the present disclosure is not limited to the above embodiment. In some embodiments, the number of channels connected to each physical space may be increased or decreased depending on the implementation method.

Each of the multiple physical spaces (PS0 to PS3) may contain multiple non-volatile memories. The first physical space (PS0) may include a plurality of non-volatile memories (1401-1, 1401-2, . . . , and 1401-3). The second physical space (PS1) may include a plurality of non-volatile memories (1402-1, 1402-2, . . . , and 1402-3). The third physical space (PS2) may include a plurality of non-volatile memories (1403-1, 1403-2, . . . , and 1403-3). The fourth physical space (PS3) may include a plurality of non-volatile memories (1404-1, 1404-2, . . . , and 1404-3). As an example, the multiple non-volatile memories (1401-1, 1401-2, . . . , and 1401-3) (included in the first physical space (PS0)) are described below.

In an embodiment, each of the first physical space to the fourth physical space (PS0 to PS3) is divided into channel units. However, the present disclosure is not limited to the above embodiment. In some embodiments, the first physical space (PS0) recognized by the host device (110) may be divided into memory block units, sub-block units, plane units, semiconductor chip units, or package units of nonvolatile memory (1401-1, 1401-2, . . . , 1401-3). The number of first physical space to the fourth physical space (PS0 to PS3) recognized by the host device (110) may be increased or decreased depending on the control of the host device (110) or the implementation of the storage device (120).

Each of the plurality of nonvolatile memories (1401-1, 1401-2, . . . , and 1401-3) may include a memory cell array including nonvolatile memory cells that are capable of retaining stored data even when power to the storage system (100) is cut off. A memory cell array may be divided into multiple memory blocks. The plurality of non-volatile memories (1401-1, 1401-2, . . . , and 1401-3) may include a plurality of super blocks including a plurality of memory blocks on a plurality of dies.

The plurality of memory blocks may have a two-dimensional horizontal structure in which the memory cells are arranged in the same plane (or layer) two dimensions, or a three-dimensional (3D) vertical structure in which the non-volatile memory cells are arranged three dimensions. A memory cell may be a single-level cell (SLC), which stores one bit of data, or a multi-level cell (MLC), which stores more than two bits of data. The present disclosure is not limited to the above embodiment. In some embodiments, each memory cell may be a Triple Level Cell (TLC) that stores 3 bits of data or a Quadruple Level Cell (QLC) that stores 4 bits of data.

Each of the plurality of non-volatile memories (1401-1, 1401-2, . . . , and 1401-3) may include a plurality of dies, or a plurality of chips, including an array of memory cells. For example, the plurality of non-volatile memories (1401-1, 1401-2, . . . , and 1401-3) may each include a plurality of chips, and the plurality of chips may each include a plurality of dies.

Each of the plurality of non-volatile memories (1401-1, 1401-2, . . . , and 1401-3) may store data or output stored data under the control of the storage controller (130). Each of the plurality of non-volatile memories (1401-1, 1401-2, . . . , and 1401-3) may be NAND flash memory. The scope of the present disclosure is not limited to the above embodiment. Each of the plurality of non-volatile memories (1401-1, 1401-2, . . . , and 1401-3) may include at least one of memories such as Static RAM (SRAM), Dynamic RAM (DRAM), Synchronous DRAM (SDRAM), Read Only Memory (ROM), Programmable ROM (PROM), Electrically Programmable ROM (EPROM), Electrically Erasable and Programmable ROM (EEPROM), flash memory devices, Phase-change RAM (PRAM), Magnetic RAM (MRAM), Resistive RAM (RRAM), and Ferroelectric RAM (FRAM).

The storage controller (130) may include an input/output manager (I/O MANAGER) (131). The input/output manager (131) may manage commands or I/O from the host device (110) so that the commands or input/output signals from the host device (110) are performed in a corresponding physical space among the first physical space to the fourth physical space (PS0 to PS3). For example, the input/output manager (131) may cause a command or I/O for the first physical space (PS0) to be performed in a plurality of nonvolatile memories (1401-1, 1401-2, . . . , and 1401-3) connected to the first channel (CH0).

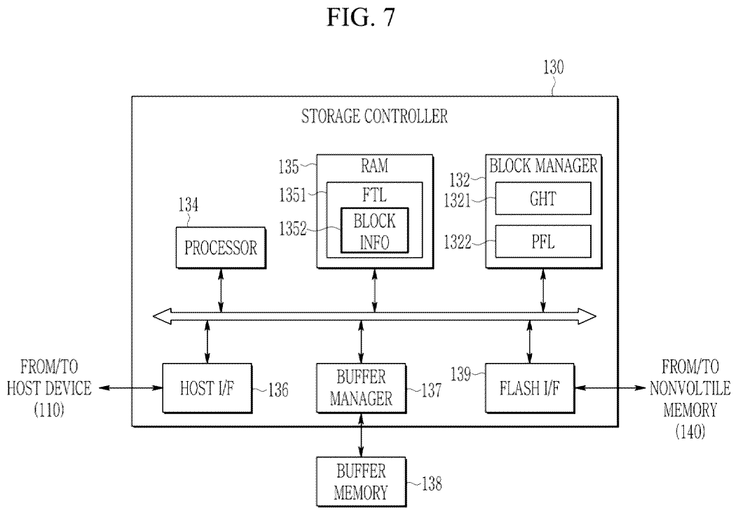

The storage controller (130) may include a block manager (132). The block manager (132) may determine a grade for a super block included in a plurality of nonvolatile memories (1401-1, 1401-2, . . . , 1401-3, 1402-1, 1402-2, . . . , 1402-3, 1403-1, 1403-2, . . . , 1403-3, 1404-1, 1404-2, . . . , and 1404-3). The block manager (132) may determine the rank of multiple super blocks among multiple ranks based on the remapping count in which one memory block among the memory blocks included in each of the multiple super blocks is mapped to another memory block and the erase count of the multiple memory blocks. A super block may share the same wordlines contained in multiple non-volatile memories (1401-1, 1401-2, . . . , 1401-3, 1402-1, 1402-2, . . . , 1402-3, 1403-1, 1403-2, . . . , 1403-3, 1404-1, 1404-2, . . . , and 1404-3). In some embodiments, the block manager (132) may determine the grades for logic blocks included in a plurality of nonvolatile memories (1401-1, 1401-2, . . . , 1401-3, 1402-1, 1402-2, . . . , 1402-3, 1403-1, 1403-2, . . . , 1403-3, 1404-1, 1404-2, . . . , and 1404-3). The block manager (132) will be described in detail in FIG. 7.

The storage controller (130) may create multiple name spaces and assign multiple name spaces to multiple tenants managed by the host device (110). The storage controller (130) may receive priority information of multiple tenants from the host. The storage controller (130) may allocate multiple super blocks to multiple name spaces based on the grade of the super block or logical block determined by the block manager (132) and the priority information of multiple tenants. In the following embodiments, the storage controller (130) allocates multiple super blocks to multiple name spaces based on the rank of the super block and priority information of multiple tenants.

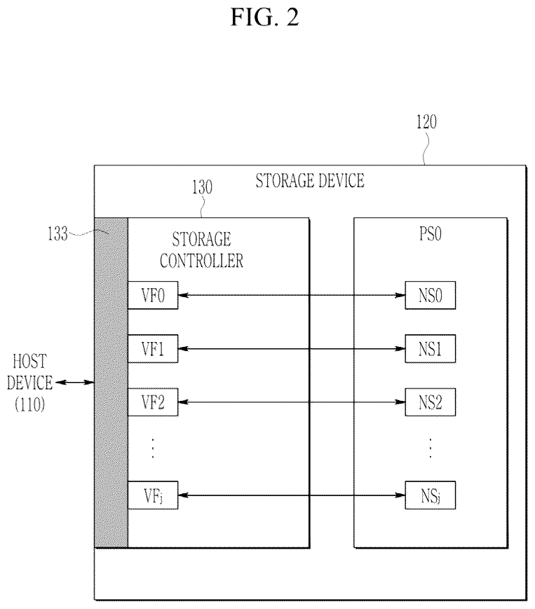

FIG. 2 illustrates a process in which a host device recognizes a physical space according to one embodiment.

Referring to FIG. 2, the host device (110) may communicate with the storage controller (130) through the first port (133). The storage controller (130) may include a plurality of virtual functions (VF0, VF1, VF2, . . . , and VFj) (VF; Virtual Functions). Multiple virtual functions (VF0, VF1, VF2, . . . , and VFj) may each be provided to multiple tenants.

For example, when virtualization technology is applied to a vehicle system, a nonvolatile memory device (140 in FIG. 1) may be segmented into multiple virtual functions. The first virtual function may allocate memory resources to the first tenant related to camera sensing. A second virtual function may allocate memory resources to a second tenant specialized in radar detection. A third virtual function may allocate memory resources to a third tenant specialized in LIDAR detection.

Multiple virtual functions (VF0, VF1, VF2, . . . , and VFj) may provide the ability to independently process commands or I/O from the host device (110). The host device (110) may recognize the first physical space (PS0) through a plurality of virtual functions (VF0, VF1, VF2, . . . , and VFj). Multiple virtual functions (VF0, VF1, VF2, . . . , and VFj) may be implemented via Single Root I/O Virtualization (SR-IOV) of the NVMe interface. The creation of multiple virtual functions (VF0, VF1, VF2, . . . , and VFj) is described in FIG. 7.

The first physical space (PS0) may include a plurality of non-volatile memories (1401-1, 1401-2, . . . , 1401-3 in FIG. 1). Multiple blocks contained in multiple non-volatile memories (1401-1, 1401-2, . . . , and 1401-3) may be allocated to multiple name spaces (NS0, NS1, NS2, . . . , and NSj). Multiple name spaces (NS0, NS1, NS2, . . . , and NSj) may be assigned to multiple tenants.

Each of the multiple virtual functions (VF0, VF1, VF2, . . . , and VFj) may be associated with one of the multiple name spaces (NS0, NS1, NS2, . . . , and NSj). For example, a first virtual function (VF0) may be associated with a first name space (NS0), and a second virtual function (VF1) may be associated with the first name space (NS0). A third virtual function (VF2) is associated with a third name space (NS2), and a virtual function (VFj) may be associated with a name space (NSj).

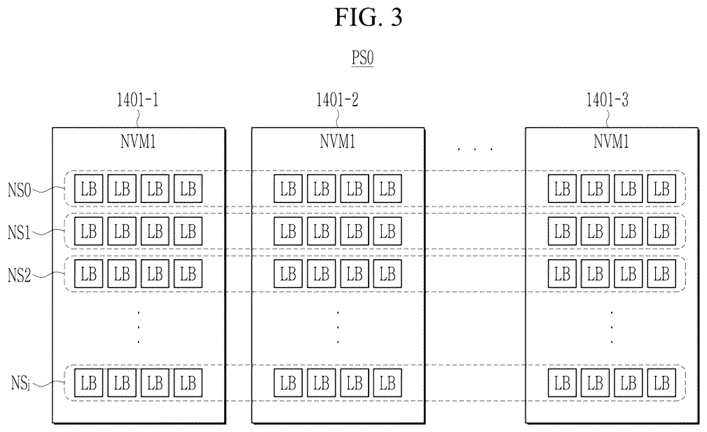

FIG. 3 illustrates an example of multiple name spaces allocated to multiple non-volatile memories according to one embodiment.

Referring to FIG. 3, each of the plurality of non-volatile memories (1401-1, 1401-2, . . . , and 1401-3) may include a plurality of logic blocks (LBs). For example, if the total capacity of the nonvolatile memory (1401-1) is 100 GB (GigaByte) and the storage capacity of the logic block (LB) is 1 GB, the nonvolatile memory (1401-1) may include 100 logic blocks (LB).

Multiple name spaces (NS0, NS1, NS2, . . . , and NSj) may be allocated to multiple logic blocks (LBs) contained in each of multiple non-volatile memories (1401-1, 1401-2, . . . , and 1401-3). The number of logic blocks (LBs) contained in multiple name spaces (NS0, NS1, NS2, . . . , and NSj) may be the same. For example, multiple name spaces (NS0, NS1, NS2, . . . , and NSj) may include four logic blocks (LBs) contained in each of multiple non-volatile memories (1401-1, 1401-2, . . . , and 1401-3).

Multiple logic blocks (LBs) containing multiple name spaces (NS0, NS1, NS2, . . . , and NSj) may share the same word line. For example, the logic blocks (LB) provided in the nonvolatile memory (1401-1) included in the first name space (NS0) may share word lines with each other. The logic blocks (LB) provided in the nonvolatile memory (1401-2) included in the first name space (NS0) may share word lines with each other. The logic blocks (LB) provided in the nonvolatile memory (1401-3) included in the first name space (NS0) may share word lines with each other.

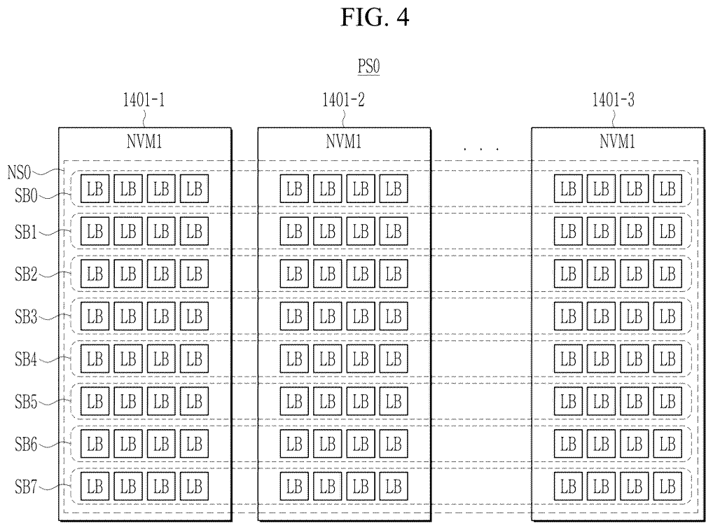

FIG. 4 illustrates an example of multiple name spaces allocated to multiple non-volatile memories according to one embodiment.

Referring to FIG. 4, the first name space (NS0) may include 32 logic blocks (LBs) contained in each of a plurality of non-volatile memories (1401-1, 1401-2, . . . , and 1401-3). At this time, 32 logic blocks (LBs) may be connected, 4 each, to 8 word lines included in multiple non-volatile memories (1401-1, 1401-2, . . . , and 1401-3).

Multiple logic blocks (LBs) may be grouped into super blocks (SB0, SB1, SB2, . . . , and SB7). Program and read operations of data may be performed in units of super blocks (SB0, SB1, SB2, . . . , and SB7). Programming and reading of data to multiple non-volatile memories (1401-1, 1401-2, . . . , and 1401-3) may be performed in parallel.

The first name space (NS0) may contain eight super blocks (SB0, SB1, SB2, . . . , and SB7). Each of the eight super blocks (SB0, SB1, SB2, . . . , and SB7) shares the same word line. For example, among the multiple logic blocks (LBs) included in the first super block (SB0), the logic blocks (LBs) included in the nonvolatile memory (1401-1) share the same word line. Among the multiple logic blocks (LBs) included in the first super block (SB0), the logic blocks (LBs) included in the nonvolatile memory (1401-2) share the same word line. Among the multiple logic blocks (LBs) included in the first super block (SB0), the logic blocks (LBs) included in the nonvolatile memory (1401-3) share the same word line.

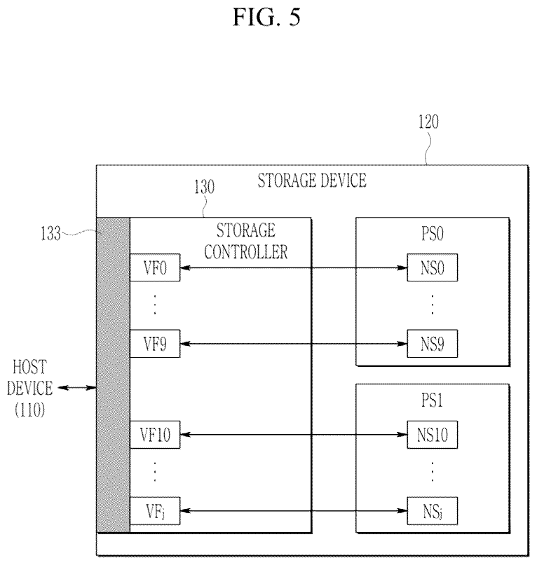

FIG. 5 illustrates a process in which a host device recognizes a physical space according to one embodiment.

Referring to FIG. 5, the host device (110) may communicate with the storage controller (130) through the first port (133). The storage controller (130) may include multiple virtual functions (VF0, VF1, VF2, . . . , and VFj). Multiple virtual functions (VF0, VF1, VF2, ..., and VFj) may provide the ability to independently process commands or I/O from the host device (110). The host device (110) may recognize multiple physical spaces (PS0, PS1, PS2, PS3 in FIG. 1) through multiple virtual functions (VF0, VF1, VF2, . . . , and VFj). Embodiments that the host device (110) recognizes the first physical space (PS0) and the second physical space (PS1) through multiple virtual functions (VF0, VF1, VF2, . . . , and VFj) are described below.

Multiple virtual functions (VF0, VF1, VF2, . . . , and VFj) may be implemented via Single Root I/O Virtualization (SR-IOV) of the NVMe interface. The creation of multiple virtual functions (VF0, VF1, VF2, . . . , and VFj) is described in FIG. 7.

The first physical space (PS0) may include a plurality of non-volatile memories (1401-1, 1401-2, . . . , and 1401-3 in FIG. 1). Multiple blocks contained in multiple non-volatile memories (1401-1, 1401-2, . . . , and 1401-3) may be allocated to multiple name spaces (NS0, . . . , and NS9). Multiple virtual functions (VF0, . . . , and VF9) may each be associated with one name space among multiple name spaces (NS0, . . . , and NS9). For example, a first virtual function (VF0) may be associated with a first name space (NS0), and a tenth virtual function (VF9) may be associated with a tenth name space (NS9).

The second physical space (PS1) may include a plurality of non-volatile memories (1402-1, 1402-2, . . . , and 1402-3 in FIG. 1). Multiple blocks contained in multiple non-volatile memories (1402-1, 1402-2, . . . , and 1402-3) may be allocated to multiple name spaces (NS10, . . . , and NSj). Each of the multiple virtual functions (VF10, . . . , and VFj) may be associated with one of the multiple name spaces (NS10, . . . , and NSj). For example, the eleventh virtual function (VF10) may be associated with the eleventh name space (NS10), and the virtual function (VFj) may be associated with the name space (NSj).

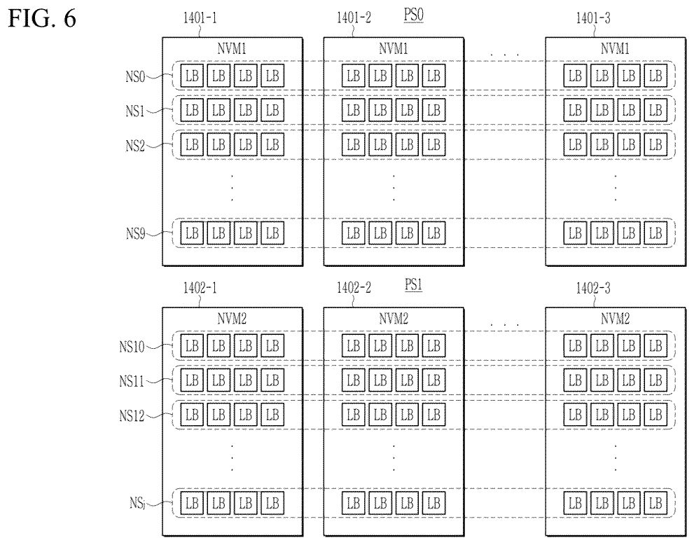

FIG. 6 illustrates an example of multiple name spaces allocated to multiple non-volatile memories according to one embodiment.

Referring to FIG. 6, a plurality of name spaces (NS0, NS1, NS2, . . . , and NS9) may be allocated to a plurality of logic blocks (LBs) included in each of a plurality of non-volatile memories (1401-1, 1401-2, . . . , and 1401-3). The number of logic blocks (LBs) contained in multiple name spaces (NS0, NS1, NS2, . . . , and NS9) may be the same. For example, multiple name spaces (NS0, NS1, NS2, ..., and NS9) may include four logic blocks (LBs) contained in each of multiple non-volatile memories (1401-1, 1401-2, . . . , and 1401-3).

Multiple logic blocks (LBs) containing multiple name spaces (NS0, NS1, NS2, . . . , and NS9) may share the same word lines. For example, the logic blocks (LB) provided in the nonvolatile memory (1401-1) included in the first name space (NS0) may share word lines with each other. The logic blocks (LB) provided in the nonvolatile memory (1401-2) included in the first name space (NS0) may share word lines with each other. The logic blocks (LB) provided in the nonvolatile memory (1401-3) included in the first name space (NS0) may share word lines with each other.

Multiple name spaces (NS10, NS11, NS12, . . . , and NSj) may be allocated to multiple logic blocks (LBs) included in each of multiple non-volatile memories (1402-1, 1402-2, . . . , and 1402-3). The number of logic blocks (LBs) contained in multiple name spaces (NS10, NS11, NS12, . . . , and NSj) may be the same. For example, multiple name spaces (NS10, NS11, NS12, . . . , and NSj) may include four logic blocks (LBs) contained in each of multiple non-volatile memories (1402-1, 1402-2, . . . , and 1402-3).

Multiple logic blocks (LBs) contained in multiple name spaces (NS10, NS11, NS12, . . . , and NSj) may share the same word line. For example, the logic blocks (LB) provided in the nonvolatile memory (1402-1) included in the 11th name space (NS10) may share word lines with each other. The logic blocks (LB) provided in the nonvolatile memory (1402-2) included in the 11th name space (NS10) may share word lines with each other. The logic blocks (LB) provided in the nonvolatile memory (1402-3) included in the 11th name space (NS10) may share word lines with each other.

FIG. 7 illustrates an example of a storage controller included in a storage device according to one embodiment.

Referring to FIG. 7, the storage controller (130) may include at least one processor (134), RAM (135), block manager (132), host interface circuit (136), buffer manager (137), and flash interface circuit (139).

The processor (134) may control the operation of the storage controller (130) in response to a command received from the host device (110) through the host interface circuit (136). The processor (134) may communicate with a nonvolatile memory device (140) via a flash interface circuit (139). The processor (134) may communicate with the buffer memory (138) through the buffer manager (137).

The processor (134) may generate multiple virtual functions (VF0, VF1, VF2, . . . , and VFj of FIG. 2). The processor (134) may create multiple name spaces (NS0, NS1, NS2, . . . , and NSj) in one physical space (PS0 in FIG. 2) using virtualization technology. Multiple virtual functions (VF0, VF1, VF2, . . . , and VFj) may access a single physical space (PS0) simultaneously. Multiple virtual functions (VF0, VF1, VF2, . . . , and VFj) may share resources such as the RAM (135), firmware, etc. From the perspective of the host device (110), the multiple virtual functions (VF0, VF1, VF2, . . . , and VFj) may be perceived as accessing data through separate hardware.

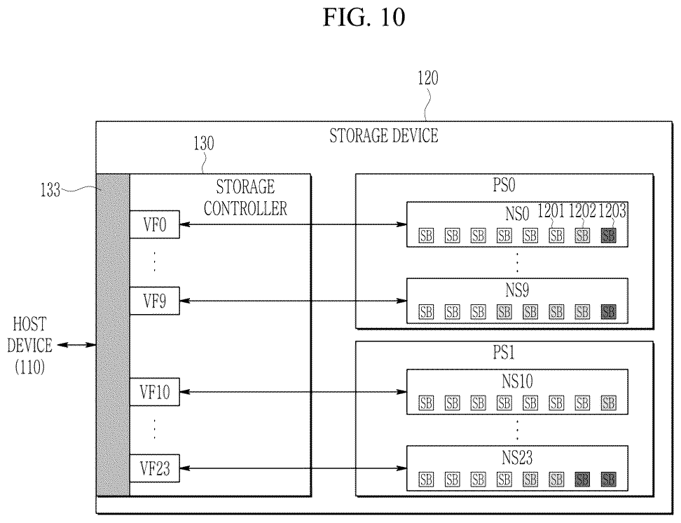

The processor (134) may allocate a plurality of super blocks included in a plurality of name spaces (NS0, NS1, NS2, . . . , and NSj) based on their respective ranks based on priority information of a plurality of tenants. This will be explained in detail in FIG. 10.

The processor (134) may control each configuration by utilizing firmware for driving the storage device (120 in FIG. 1).

The RAM (135) may be used as operating memory, cache memory, or buffer memory of the processor (134). The RAM (135) may store codes and instructions executed by the processor (134). The RAM (135) may store data processed by the processor (134). The RAM (135) may be implemented as, for example, DRAM (Dynamic RAM) or SRAM (Static RAM). The RAM (135) may store firmware and data for controlling the storage controller (130). The stored firmware and data may be driven or processed by the processor (134). The software layer structure of the storage controller (130) implemented as firmware may include a flash translation layer (FTL) (1351).

The flash translation layer (1351) may manage read and write operations of the nonvolatile memory device (140). The flash translation layer (1351) may perform address mapping, garbage collection, read reclaim, and wear leveling for interfacing between a plurality of nonvolatile memories (1401-1, 1401-2, . . . , 1401-3, 1402-1, 1402-2, . . . , 1402-3, 1403-1, 1403-2, . . . , 1402-3, 1404-1, 1404-2, . . . , and 1404-3 of FIG. 1) and the host device (110).

The flash conversion layer (1351) may include a block info table (1352). The block info table (1352) may include NAND type, block type, block grade, garbage collection count, read reclaim count, and wear leveling count. NAND types may include single-level cells, multi-level cells, triple-level cells, and quadruple-level cells. Block types may include user blocks, reserved blocks, and free blocks. The grade of a block may include the grade of a superblock.

The number of garbage collections may include the number of garbage collections that occurred for each of user blocks, reserved blocks, and free blocks. The number of lead reclaims may include the number of lead reclaims that occurred for each of user blocks, reserved blocks, and free blocks. The wear leveling count may include the number of wear leveling counts that occurred in each of the user blocks, reserved blocks, and free blocks.

The firmware may be updated based on the block info table (1352). The updated firmware may be driven or processed by the processor (134).

The block manager (132) may include a graded hash table (GHT) (1321) and a graded loop diagram (PFL) (1322). The grade hash table (1321) may include grades (GRADE) of multiple super blocks, indices (INDEX) of the super blocks, global remapping counts (GRC) of the super blocks, and erase counts (EC) of the super blocks.

The grade determination circuit (1322) may determine the grade (GRADE) of the super block by referring to the grade hash table (1321). The grade determination circuit (1322) may determine the grade (GRADE) of the super block based on multiple parameters in the grade hash table (1321). The multiple parameters may include global remapping count (GRC) and superblock erase count (EC).

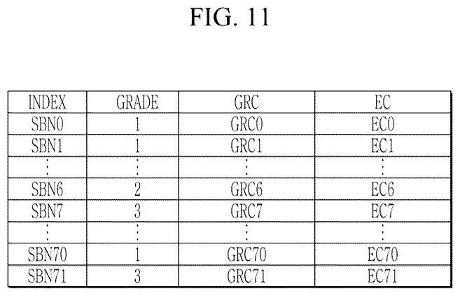

The grade hash table (1321) and the grade determination circuit (1322) will be described in detail in FIG. 11.

The host interface circuit (136) may provide a physical connection between the host device (110) and the storage device (120). The host interface circuit (136) may provide interfacing with the storage device (120) corresponding to the bus format of the host device (110). At least one of various interface methods such as USB, MMC, PCI-E, ATA, SATA, PATA, SCSI, SAS, ESDI, IDE, NVMe, etc. may be applied to the host interface circuit (136).

The flash interface circuit (139) may communicate with a nonvolatile memory device (140). The flash interface circuit (139) may transmit data to a plurality of nonvolatile memories (1401-1, 1401-2, . . . , 1401-3, 1402-1, 1402-2, . . . , 1402-3, 1403-1, 1403-2, . . . , 1402-3, 1404-1, 1404-2, . . . , and 1404-3) and may receive data read from a plurality of nonvolatile memories (1401-1, 1401-2, . . . , 1401-3, 1402-1, 1402-2, . . . , 1402-3, 1403-1, 1403-2, . . . , 1402-3, 1404-1, 1404-2, . . . , and 1404-3). there is. The flash interface circuit (139) may be connected to a plurality of nonvolatile memories (1401-1, 1401-2, . . . , 1401-3, 1402-1, 1402-2, . . . , 1402-3, 1403-1, 1403-2, . . . , 1402-3, 1404-1, 1404-2, . . . , and 1404-3) through a plurality of channels (CH0, CH1, CH2, and CH3 in FIG. 1).

The buffer manager (137) may be configured to control the buffer memory (138) under the control of the processor (134). The buffer manager (137) controls the buffer memory (138) to temporarily store data exchanged between the nonvolatile memory device (140) and the host device (110).

Buffer memory (138) may store commands and data executed and processed by the storage controller (130). The buffer memory (138) may temporarily store data that is stored in a nonvolatile memory device (140) or data to be stored.

The buffer memory (138) may be implemented as volatile memory such as DRAM (Dynamic Random Access Memory), SRAM (Static RAM), etc. The present disclosure is not limited to the above embodiment. The buffer memory (138) may be implemented with various types of nonvolatile memory, such as a resistive nonvolatile memory such as MRAM (magnetic RAM), PRAM (phase change RAM), or ReRAM (resistive RAM), flash memory, NFGM (Nano Floating Gate Memory), PoRAM (Polymer Random Access Memory), or FRAM (Ferroelectric Random Access Memory). In this embodiment, the buffer memory (138) is illustrated as being provided outside the storage controller (130). The present disclosure is not limited to the above embodiment. In another embodiment, the buffer memory (138) may be provided inside the storage controller (130).

The storage controller (130) may further include an ECC (Error Checking and Correcting) engine that performs ECC encoding and ECC decoding using coded modulation such as Bose-Chaudhuri-Hocquenghem (BCH) code, Low Density Parity Check (LDPC) code, Turbo Code, Reed-Solomon Code, Convolution Code, Recursive Systematic Code (RSC), Trellis-Coded Modulation (TCM), Block Coded Modulation (BCM), or other error correction codes.

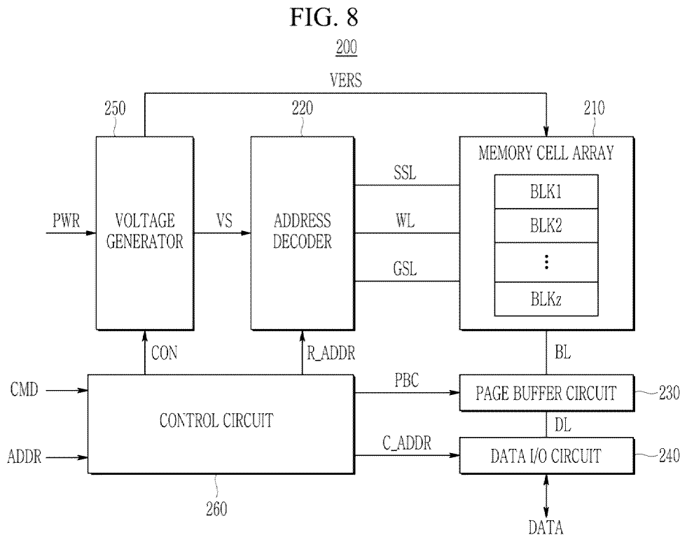

FIG. 8 illustrates an example of a nonvolatile memory according to one embodiment.

Referring to FIG. 8, the nonvolatile memory (200) may include a memory cell array (210), an address decoder (220), a page buffer circuit (230), a data input/output circuit (240), a voltage generator (250), and a control circuit (260). For example, the nonvolatile memory (200) may be one of a plurality of nonvolatile memories (1401-1, 1401-2, . . . , 1401-3, 1402-1, 1402-2, . . . , 1402-3, 1403-1, 1403-2, . . . , and 1403-3 of FIG. 1).

The memory cell array (210) may be connected to an address decoder (220) through a plurality of string select lines (SSL), a plurality of word lines (WL), and a plurality of ground select lines (GSL). Additionally, the memory cell array (210) may be connected to a page buffer circuit (230) through a plurality of bit lines (BL). A memory cell array (210) may include a plurality of memory cells connected to a plurality of word lines (WL) and a plurality of bit lines (BL). The memory cell array (210) may be divided into a plurality of memory blocks (BLK1, BLK2, . . . , BLKz) each including memory cells. Additionally, each of the multiple memory blocks (BLK1 to BLKz) may be divided into multiple pages.

According to an embodiment, the memory cell array (210) may be a form of a two-dimensional array structure or a three-dimensional vertical array structure.

The control circuit (260) may be configured to receive a command (CMD) and an address (ADDR) from an external source (e.g., a host device (110 of FIG. 1) and/or a storage controller (130 of FIG. 1)), and controls an erase loop, a program loop, and a read operation of the nonvolatile memory (200) based on the command (CMD) and the address (ADDR). Here, the program loop may include program operations and program verification operations, and the erase loop may include erase operations and erase verification operations. Here, the read operation may include a normal read operation and a data recovery read operation.

For example, the control circuit (260) may generate control signals (CON) for controlling the voltage generator (250) and control signals (PBC) for controlling the page buffer circuit (230) based on the command (CMD), and may generate a row address (R_ADDR) and a column address (C_ADDR) based on the address (ADDR). The control circuit (260) may provide a row address (R_ADDR) to the address decoder (220) and a column address (C_ADDR) to the data input/output circuit (240).

The address decoder (220) may be connected to the memory cell array (210) through a plurality of string select lines (SSL), a plurality of word lines (WL), and a plurality of ground select lines (GSL).

For example, during an erase/program/read operation, the address decoder (220) may determine at least one of the plurality of word lines (WL) as a selected word line in response to a row address (R_ADDR), and determine the remaining word lines, excluding the selected word line, among the plurality of word lines (WL), as non-selected word lines.

Additionally, during an erase/program/read operation, the address decoder (220) may determine at least one of the plurality of string selection lines (SSL) as a selected string selection line and determine the remaining string selection lines as non-selected string selection lines in response to the row address (R_ADDR).

Additionally, during an erase/program/read operation, the address decoder (220) may determine at least one of a plurality of ground selection lines (GSL) as a selected ground selection line and determine the remaining ground selection lines as non-selected ground selection lines in response to a row address (R_ADDR).

A voltage generator (250) may generate voltages (VS) required for the operation of a nonvolatile memory (200) based on a power supply voltage (PWR) and control signals (CON). Voltages (VS) may be applied to a plurality of string select lines (SSL), a plurality of word lines (WL) and a plurality of ground select lines (GSL) through an address decoder (220). Additionally, the voltage generator (250) may generate an erase voltage required for the erase operation based on the power supply voltage (PWR) and control signals (CON). The erase voltage may be applied directly to the memory cell array (210) or through a bit line (BL).

For example, during an erase operation, a voltage generator (250) may apply an erase voltage to a common source line and/or a bit line (BL) of one memory block, and may apply an erase allowance voltage (e.g., a ground voltage) to all word lines of one memory block or word lines corresponding to some sub-blocks through an address decoder (220). During an erase verification operation, the voltage generator (250) may apply an erase verification voltage to all word lines of one memory block or apply an erase verification voltage per word line.

For example, during a program operation, the voltage generator (250) may apply a program voltage to the selected word line and a program inhibit voltage to the non-selected word lines through the address decoder (220). During a program verification operation, the voltage generator (250) may apply a program verification voltage to the selected word lines through the address decoder (220) and apply a verification pass voltage to the non-selected word lines.

Additionally, during normal read operation, the voltage generator (250) may apply a read voltage to the selected word line through the address decoder (220) and apply a read pass voltage to the non-selected word lines. Additionally, during a data recovery read operation, the voltage generator (250) may apply a read voltage to a word line adjacent to the selected word line through the address decoder (220), and apply a recovery read voltage to the selected word line.

The page buffer circuit (230) may be connected to the memory cell array (210) through a plurality of bit lines (BL). The page buffer circuit (230) may include multiple page buffers. In one embodiment, one bit line may be connected to one page buffer. In another embodiment, more than two bit lines may be connected to a single page buffer.

The page buffer circuit (230) may store write data to be programmed into the memory cell array (210) or store read data detected from the memory cell array (210). The page buffer circuit (230) may operate as a write driver or a sense amplifier depending on the operating mode of the nonvolatile memory (200).

The data input/output circuit (240) may be connected to the page buffer circuit (230) through data lines (DL). The data input/output circuit (240) may provide write data to the memory cell array (210) via the page buffer circuit (230) in response to the column address (C_ADDR), or may provide read data output from the memory cell array (210) via the page buffer circuit (230) to the outside.

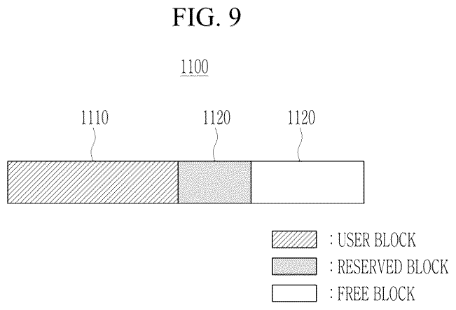

FIG. 9 illustrates an example of the number of blocks according to one embodiment.

Referring to FIGS. 8 and 9 together, a plurality of blocks within the memory cell array (210) may be assigned to three types of blocks. In some embodiments, the memory cell array (210) may be allocated to a user block (1110), a reserved block (1120), and a free block (1130).

The user block (1110) may be a block in which a user may enter data or read data. The storage controller (130 in FIG. 7) may write data (DATA) to a user block (1110) or read data (DATA) from a user block (1110) by transmitting a command (CMD), an address (ADDR), and data (DATA).

A reserved block (1120) may be a block from which the storage controller (130) cannot write data (DATA) or read data (DATA). A reserved block (1120) may be a block predefined for replacement of a bad block in which it is impossible to write or read data due to a process error.

A free block (1130) may be a block that does not store valid user data. Free blocks (1130) are blocks for which an erase operation has been completed and may be blocks for which program operations may be performed again. A free block (1130) may be an area for performing garbage collection. For example, blocks that are reused after performing a garbage collection operation may be used as user blocks or free blocks.

FIG. 10 illustrates a plurality of super blocks each including a plurality of virtual functions and a plurality of name spaces each associated with a plurality of virtual functions according to one embodiment.

Referring to FIG. 10, the host device (110) may communicate with the storage controller (130) through the first port (133). The storage controller (130) may include multiple virtual functions (VF0, VF1, VF2, . . . , and VF23). Multiple virtual functions (VF0, VF1, VF2, . . . , and VF23) may each be provided to multiple tenants.

Multiple virtual functions (VF0, . . . , and VF9) may provide the ability to independently process commands or I/O from the host device (110). The host device (110) may recognize a first physical space (PS0) including a plurality of name spaces (NS0, . . . , and NS9) through a plurality of virtual functions (VF0, . . . , and VF9). The host device (110) may recognize a second physical space (PS1) including a plurality of name spaces (NS10, . . . , and NS23) through a plurality of virtual functions (VF10, . . . , VF23).

Multiple name spaces may contain multiple super blocks (SBs). For example, a name space (NS0) may contain multiple super blocks (SB).

Multiple super blocks (SB) may be allocated to each of multiple name spaces (NS0, . . . , and NS23) based on the ranks of the multiple super blocks (SB). Embodiments that each of the multiple super blocks (SBs) is determined as one of the three grades: 1st grade, 2nd grade, and 3rd grade, are described below.

As illustrated in FIG. 10, six first-class super blocks (1201), one second-class super block (1202), and one third-class super block (1203) may be allocated to the name space (NS0). The 10th namespace (NS9) may be allocated three first-class superblocks (1201), four second-class superblocks (1202), and one third-class superblock (1203). The 11th name space (NS10) may be allocated seven first-class super blocks (1201) and one second-class super block (1202). The 24th namespace (NS23) may be allocated four superblocks of the first class (1201), two superblocks of the second class (1202), and two superblocks of the third class (1203). The number of super blocks (1201, 1202, and 1203) of each class contained in each of the multiple name spaces (NS0 to NS23) is for illustrative purposes only. Although it has been explained that the grades of super blocks are divided into three grades, the number of grades is not limited to the above embodiment.

The rating for a super block (SB) may be determined based on the global remapping count (GRC) and the erase count (EC). The global remap count (GRC) and erase count (EC) for each super block (SB) may be stored in a grade hash table.

FIG. 11 illustrates a grade hash table according to one embodiment.

Referring to FIG. 11, the grade hash table (1321 of FIG. 7) may include a grade of a super block (GRADE), an index of a super block (INDEX), a global remapping count (GRC) of a super block, and an erase count (EC) of a super block. At this time, the super block may contain multiple memory blocks on multiple dies and sharing word lines.

The index (INDEX) of a super block may indicate identification information (e.g., number, index) of a super block included in each of multiple name spaces (NS0 to NS23). For example, the index (INDEX) of a super block may indicate identification information (SBN0, SBN1, SBN2, . . . , and SBN71) for super blocks (SB0, SB1, SB2, . . . , SB71) included in the first physical space (PS0). However, this is only an example, and if the unit allocated to the name space is a logic block, the index of the logic block may include the address of the logic block.

The grade of a superblock may be divided into multiple categories. The grade decision circuit (1322 of FIG. 7) may read the remapping count of the plurality of super blocks and the erase count of the plurality of super blocks from the grade hash table. The grade determination circuit (1322) may determine the grade (GRADE) of the super block based on the global remapping count (GRC) of the super block and the erase count (EC) of the super block. In some embodiments, the grade determination circuit (1322) may determine the grade (GRADE) of a super block by setting weights for each of the global remapping count (GRC) of the super block and the erase count (EC) of the super block.

$$GRADE INDEX = GRC PERCENTILE * A + EC PERCENTILE * B \qquad ( Equation 1 )$$

Here, GRADE INDEX is a grade index for determining a grade, GRC PERCENTILE is a percentile (PERCENTILE) of the super block among all super blocks determined by the global remapping count (GRC) of the super block, and EC PERCENTILE may be a percentile of the super block among all super blocks determined by the erase count (EC) of the super block. Here, A and B are weights, and in some embodiments, A B may be 1.

For example, the rating decision circuit (1322) may set a weight of 0.8 for the global remapping count (GRC) of the super block and a weight of 0.2 for the erase count (EC) of the super block. The grade determination circuit (1322) calculates a grade index (GRADE INDEX) of a super block based on the set weights, and may determine a percentile of the corresponding super block among all super blocks using the grade index (GRADE INDEX). The grade determination circuit (1322) may determine the grade (GRADE) based on the percentile of the corresponding super block. For example, the grade decision circuit (1322) may determine a grade of 1 if the percentile of the super block is greater than 0 and less than or equal to 33, a grade of 2 if it is greater than 33 and less than or equal to 66, and a grade of 3 if it is greater than 66 and less than or equal to 100. The logic for determining the grade (GRADE) of a super block by the global remapping count (GRC) of the super block and the erase count (EC) of the super block in the grade hash table (1321) may be a result performed from the grade determination circuit (1322).

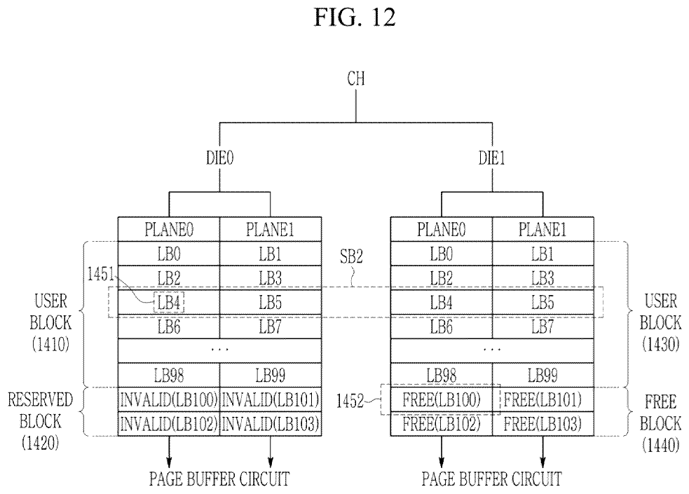

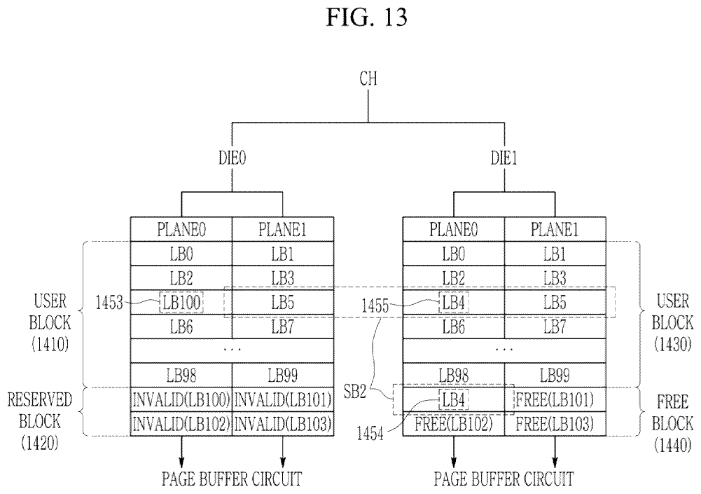

FIGS. 12 and 13 illustrate counting of the number of global remapping count of a super block.

Referring to FIG. 4, FIG. 12, and FIG. 13, a first die (DIE0) and a second die (DIE1) may be connected to one channel (CH). The first die (DIE0) and the second die (DIE1) may each include a first plane (PLANE0) and a second plane (PLANE1). The first plane (PLANE0) may include logic blocks (LB0, LB2, LB4, LB6, . . . , LB98, LB100, and LB102). The second plane (PLANE1) may include logic blocks (LB1, LB3, LB5, LB7, . . . , LB99, LB101, and LB103). The number of channels (CH), the number of dies (DIE) connected to the channels (CH), the number of planes (PLANE) included in the die (DIE), and the number of logic blocks (LB) included in the plane (PLANE) are only examples.

The first die (DIE0) may include a user block (1410) and a reserved block (1420). The user block (1410) may include a plurality of logic blocks (LB0, LB1, LB2, . . . , and LB99). The reserved block (1420) may include a plurality of logic blocks (LB100, LB101, LB102, and LB103).

The second die (DIE1) may include a user block (1430) and a free block (1440). The user block (1430) may include a plurality of logic blocks (LB0, LB1, LB2, . . . , and LB99). The free block (1440) may include multiple logic blocks (LB100, LB101, LB102, and LB103).

The second super block (SB2) may include a plurality of logic blocks (LB4, and LB5) included in the user block (1410) and a plurality of logic blocks (LB4, and LB5) included in the user block (1430).

The logic block (LB4) included in the user block (1410) may be a bad block (BAD BLOCK) (1451). The second super block (SB2) may not be able to perform normal data read/write operations due to a bad block (1451). Normal data read/write operations of the second super block (SB2) may be performed only when the bad block (1451) is mapped to a normal block (NORMAL BLOCK) included in the first die (DIE0) or a normal block included in the second die (DIE1).

A plurality of logic blocks (LB100, LB101, LB102, and LB103) included in the reserved block (1420) may be in a state of storing invalid data (INVALID). A plurality of logic blocks (LB100, LB101, LB102, and LB103) included in the free block (1440) may not be storing any data and thus may be in a state (FREE) in which new data may be stored. In this case, the bad block (1451) may be mapped (REMAP) to a normal block (1452) of one of the multiple logic blocks (LB100, LB101, LB102, and LB103) included in the second die (DIE1).

Referring to FIG. 13, the first plane (PLANE0) of the first die (DIE0) may include a first mapping block (1453), which is a block to which data stored in a normal block (1452) is mapped. The first plane (PLANE0) of the second die (DIE1) may include a second mapping block (1454), which is a block to which data stored in the bad block (1451) is mapped.

Nonvolatile memory (1401-1, 1401-2, . . . , 1401-3, 1402-1, 1402-2, . . . , 1402-3, 1403-1, 1403-2, . . . , 1403-3, 1404-1, 1404-2, . . . , and 1404-3 in FIG. 1) may store and manage data in plane units. Multiple logic blocks included in the same plane share the same transmission path and control signals, so only one block may be accessed at a time.

For example, when performing a program and read operation for the second super block (SB2), one of the plurality of logic blocks (1454 and 1455) included in the first plane (PLANE0) of the second die (DIE1) may be performed first. The second mapping block (1454) may be a block to which data stored in the bad block (1451) is mapped. The logic block (1455) may be a logic block included in the second super block (SB2) before the second mapping block (1454) is mapped.

The page buffer circuit (230 in FIG. 8) may be connected to the second super block (SB2) through a plurality of bit lines (BL). The page buffer circuit (230) may include multiple page buffers. One bit line may be connected to one page buffer.

When the page buffer circuit (230) processes data stored in multiple pages, the transmission path and control signals of the plane may be shared. When accessing multiple pages, the transmission latency between each page may increase. For example, when the page buffer circuit (230) accesses a page included in each of a plurality of logic blocks (1454 and 1455), the transmission waiting time between each page may increase.

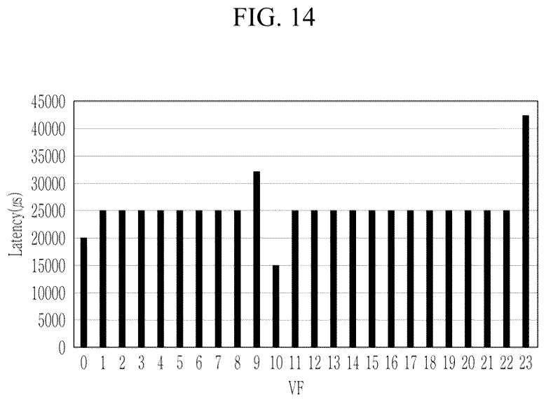

FIG. 14 is a graph showing the delay time occurring in multiple virtual functions.

Referring to FIG. 10 and FIG. 14, each of the plurality of virtual functions (VF0, . . . , and VF23) may be associated with one name space among the plurality of name spaces (NS0, . . . , and NS23). The first name space (NS0) may be allocated six first-class superblocks (1201), one second-class superblock (1202), and one third-class superblock (1203). Three first-class superblocks (1201), four second-class superblocks (1202), and one third-class superblock (1203) may be allocated in the 10th namespace (NS9). The 11th name space (NS10) may be allocated with seven first-class superblocks (1201) and one second-class superblock (1202). Four first-class superblocks (1201), two second-class superblocks (1202), and two third-class superblocks (1203) may be allocated in the 24th namespace (NS23). And, In an embodiment, five first-class super blocks (1201), two second-class super blocks (1202), and one third-class super block (1203) are allocated to the second name space to the ninth name space (NS1-NS8) and the 12th name space to the 23rd name space (NS11-NS22).

In one embodiment, the greater the number of third-class super blocks (1203) included in each of the plurality of name spaces (NS0 to NS23), the longer the latency may be. Latency may include the time required to process a command or I/O received from a host device (110 in FIG. 1). As latency increases, Quality Of Service (QoS) may deteriorate.

For example, the number of third-class super blocks (1203) included in the 24th name space (NS23) associated with the 24th virtual function (VF23) may be two, which is greater than the number of third-class super blocks (1203) included in the 1st to 23rd name spaces (NS0-NS22). The latency of the 24th virtual function (VF23) may be 42000 (μs), which may be longer than the latency of the 1st to 23rd virtual functions (VF0-VF23).

In one embodiment, if the number of third-class super blocks (1203) included in each of the plurality of name spaces (NS0-NS23) is the same, the greater the number of second-class super blocks (1202), the longer the latency may be.

For example, the number of third-class super blocks (1203) included in the first name space (NS0) associated with the first virtual function (VF0) and the number of third-class super blocks (1203) included in the tenth name space (NS9) associated with the tenth virtual function (VF9) are equal to 1. However, the number of second-class super blocks (1202) included in the 10th name space (NS9) associated with the 10th virtual function (VF9) may be 4, which is greater than the number of second-class super blocks (1202) included in the 1st name space (NS0) associated with the 1st virtual function (VF0). The latency of the 10th virtual function (VF9) may be 32000 (μs), which is longer than the latency of the 1st virtual function (VF0), which is 20000 (μs).

The second name space to the ninth name space (NS1-NS8) and the twelfth to 23rd name spaces (NS11-NS22) associated with the second to ninth virtual functions (VF1-VF8) and the twelfth to 23rd virtual functions (VF11-VF22) may each include five first-class super blocks (1201), two second-class super blocks (1202), and one third-class super block (1203). The latency of the second to ninth virtual functions (VF1-VF8) and the twelfth to 23rd virtual functions (VF11-VF22) may be 32000 (μs), which is longer than the latency of the first virtual function (VF0), which is 23000 (μs).

An eleventh name space (NS10) associated with an eleventh virtual function (VF10) may include seven first-class super blocks (1201) and one second-class super block (1202). The latency of the 11th virtual function (VF10) may be 15000 (μs), which may be shorter than the latency of the 1st to 10th virtual functions (VF0-VF9) and the 12th to 24th virtual functions (VF11-VF23). Since the latency of the 11th virtual function (VF10) is shorter than the latency of the 24th virtual function (VF23), a tenant provided with the 11th virtual function (VF10) may be provided with a better QoS than a tenant provided with the 24th virtual function (VF23).

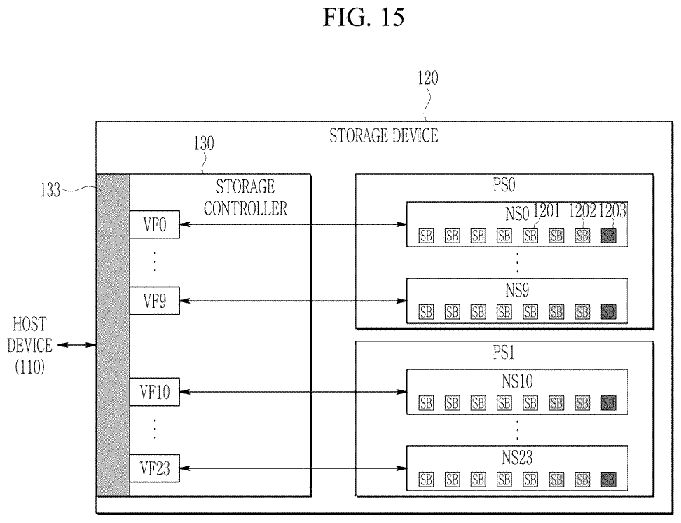

FIG. 15 illustrates a plurality of super blocks each including a plurality of virtual functions and a plurality of name spaces each associated with a plurality of virtual functions according to one embodiment.

A processor (134 in FIG. 7) may allocate multiple super blocks included in multiple name spaces (NS0, . . . , NS23) based on their respective ranks based on priority information of multiple tenants. At this time, if the priorities of multiple tenants are the same, the processor (134) may equally allocate multiple super blocks included in multiple name spaces (NS0, . . . , NS23).

For example, the processor (134) may allocate five first-class super blocks (1201), two second-class super blocks (1202), and one third-class super block (1203) to each of a plurality of name spaces (NS0, . . . , NS23 of FIG. 10). The processor (134) may swap and allocate one second-class super block (1202) allocated to the 10th name space (NS9 of FIG. 10) with one first-class super block (1201) allocated to the 1st name space (NS0 of FIG. 10). The processor (134) may swap one second-class super block (1202) allocated to the 10th name space (NS9 of FIG. 10) with one first-class super block (1201) allocated to the 11th name space (NS10 of FIG. 10). The processor (134) may swap one third-class super block (1203) allocated to the 24th name space (NS23 of FIG. 10) with another first-class super block (1201) allocated to the 11th name space (NS10 of FIG. 10).

Accordingly, referring to FIG. 15, each of the plurality of virtual functions (VF0, . . . , VF23) may be associated with one of the plurality of name spaces (NS10, . . . , NS23). The first to twenty-fourth namespaces (NS0-NS23) may each include five super blocks of the first class (1201), two super blocks of the second class (1202), and one super block of the third class (1203).

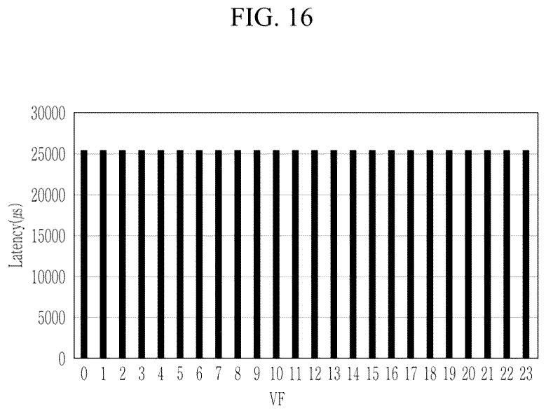

FIG. 16 is a graph showing the delay time occurring in multiple virtual functions.

Referring to FIGS. 15 and 16, each of the plurality of virtual functions (VF0, . . . , and VF23) may be associated with one of the plurality of name spaces (NS0, . . . , and NS23). The first through twenty-fourth namespaces (NS0, . . . , and NS23) may each include five super blocks of the first class (1201), two super blocks of the second class (1202), and one super block of the third class (1203). The latency of the first to 24th virtual functions (VF0-VF23) may be the same as 23200 (μs).

Since the latency of the first to 24th virtual functions (VF0-VF23) is the same, multiple tenants each receiving the first to 24th virtual functions (VF0-VF23) may receive the same QoS.

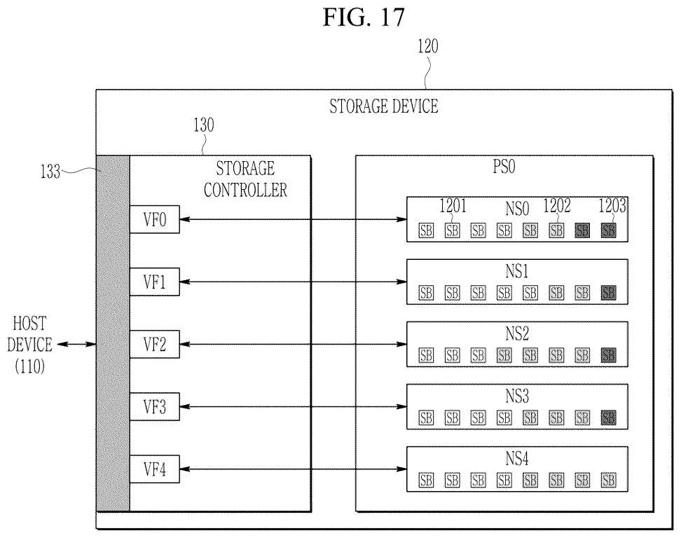

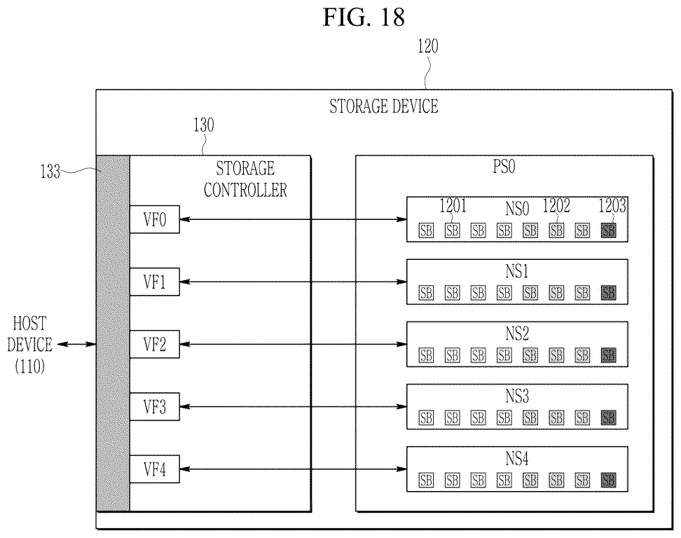

FIG. 17 illustrates a plurality of super blocks each including a plurality of virtual functions and a plurality of name spaces each associated with a plurality of virtual functions according to one embodiment. FIG. 18 illustrates a plurality of super blocks equally allocated to a plurality of virtual functions and a plurality of name spaces each associated with a plurality of virtual functions according to one embodiment.

Referring to FIG. 17, each of the plurality of virtual functions (VF0, . . . , and VF4) may be associated with one name space among the plurality of name spaces (NS0, . . . , and NS4) included in the first physical space (PS0). A first virtual function (VF0) may be associated with a first name space (NS0), a second virtual function (VF1) may be associated with a second name space (NS1), and a third virtual function (VF2) may be associated with a third name space (NS2). A fourth virtual function (VF3) may be associated with a fourth name space (NS3), and a fifth virtual function (VF4) may be associated with a fifth name space (NS4).

The first to fifth name spaces (NS0-NS4) may each be allocated eight super blocks. A first name space (NS0) may be allocated four first-class super blocks (1201), two second-class super blocks (1202), and two third-class super blocks (1203). A second name space (NS1) may be allocated five first-class super blocks (1201), two second-class super blocks (1202), and one third-class super block (1203). A third namespace (NS2) may be allocated three first-class superblocks (1201), four second-class superblocks (1202), and one third-class superblock (1203). A fourth namespace (NS3) may be allocated four first-class superblocks (1201), three second-class superblocks (1202), and one third-class superblock (1203). The fifth name space (NS4) may be allocated four super blocks of the first class (1201) and four super blocks of the second class (1202).

The first name space to the fifth namespace (NS0-NS4) may be allocated 40 levels of super blocks, including 20 level 1 super blocks (1201), 15 level 2 super blocks (1202), and 5 level 3 super blocks (1203).

Referring to FIG. 18, the processor (134 of FIG. 7) may allocate a plurality of super blocks included in a plurality of name spaces (NS0, . . . , and NS4) based on their respective ranks based on priority information of a plurality of tenants. The processor (134) may determine that the priorities of multiple tenants are the same based on priority information about the multiple tenants. The processor (134) may allocate multiple super blocks to multiple name spaces such that the number of super blocks of the same grade included in each of the multiple name spaces is substantially the same for each of the multiple name spaces.

For example, the processor (134) may cause four first-class super blocks (1201), three second-class super blocks (1202), and one third-class super block (1203) to be allocated to each of a plurality of name spaces (NS0, . . . , and NS4).

The processor (134) may allocate one third-class super block (1203) included in the first name space (NS0 of FIG. 17) by exchanging it with one second-class super block (1202) included in the fifth name space (NS4 of FIG. 17). The processor (134) may allocate a second-class super block (1202) included in a third name space (NS2 of FIG. 17) by exchanging it with one first-class super block (1201) included in a second name space (NS1 of FIG. 17).

Accordingly, referring to FIG. 18, four first-class super blocks (1201), three second-class super blocks (1202), and one third-class super block (1203) may be allocated to the first to fifth name spaces (NS0-NS4). Multiple tenants, each of which is provided with the first to fifth virtual functions (VF0-VF4), may be provided with the same QoS.

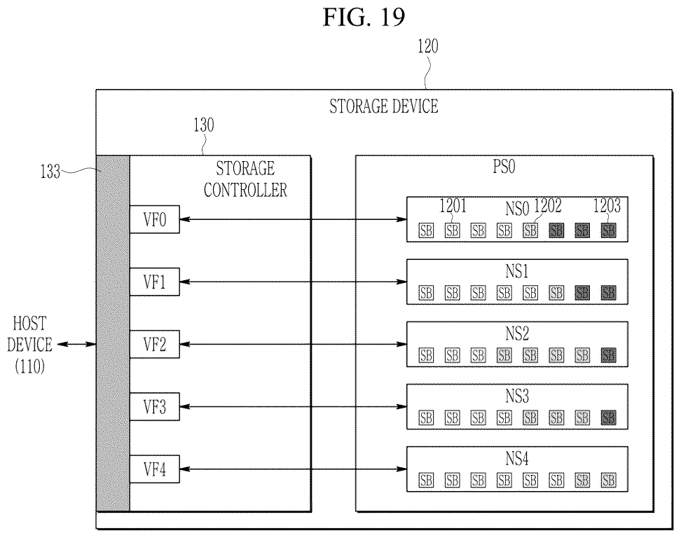

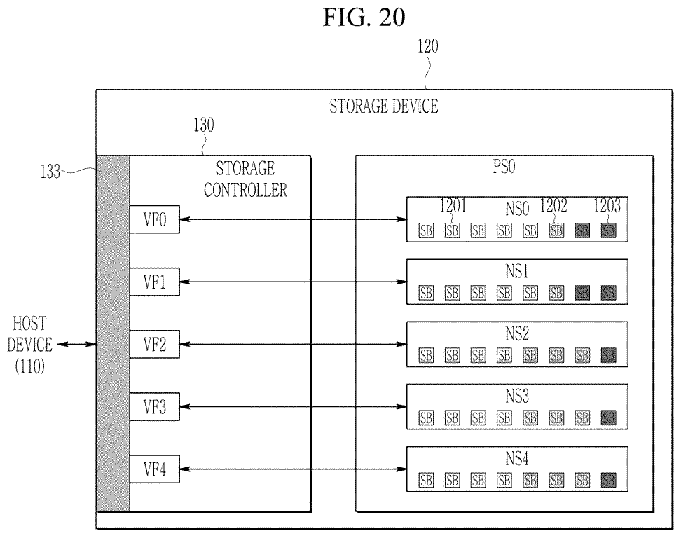

FIG. 19 illustrates a plurality of super blocks each including a plurality of virtual functions and a plurality of name spaces each associated with the same, according to one embodiment. FIG. 20 illustrates a plurality of super blocks, each of which includes a plurality of virtual functions and a plurality of name spaces, each of which is associated with a plurality of virtual functions, allocated unevenly according to one embodiment.

Referring to FIG. 19, a plurality of virtual functions (VF0, . . . , and VF4) may each be associated with one name space among a plurality of name spaces (NS0, . . . , and NS4) included in a first physical space (PS0). A first virtual function (VF0) may be associated with a first name space (NS0), a second virtual function (VF1) may be associated with a second name space (NS1), and a third virtual function (VF2) may be associated with a third name space (NS2). A fourth virtual function (VF3) may be associated with a fourth name space (NS3), and a fifth virtual function (VF4) may be associated with a fifth name space (NS4).

Each of the first to fifth name spaces (NS0-NS4) may be allocated eight levels of super blocks. A first name space (NS0) may be allocated four first-class super blocks (1201), one second-class super block (1202), and three third-class super blocks (1203). A second name space (NS1) may be allocated five first-class super blocks (1201), one second-class super block (1202), and two third-class super blocks (1203). A third namespace (NS2) may be allocated three first-class superblocks (1201), four second-class superblocks (1202), and one third-class superblock (1203). A fourth namespace (NS3) may be allocated four first-class superblocks (1201), three second-class superblocks (1202), and one third-class superblock (1203). The fifth namespace (NS4) may be allocated six first-class superblocks (1201) and two second-class superblocks (1202).

The first name space to the fifth namespace (NS0-NS4) may be allocated 40 levels of super blocks, including 22 level 1 super blocks (1201), 11 level 2 super blocks (1202), and 7 level 3 super blocks (1203).

A processor (134 in FIG. 7) may allocate a plurality of super blocks included in a plurality of name spaces (NS0, . . . , and NS4 in FIG. 19) based on their respective ranks based on priority information of a plurality of tenants. The processor (134) may determine that the priorities of multiple tenants are different based on priority information about the multiple tenants. The processor (134) may allocate multiple super blocks to multiple name spaces such that the number of super blocks of the same grade included in each of the multiple name spaces is different for each of the multiple name spaces.

In some embodiments, if the priorities of multiple tenants are the same, the processor (134) may equally allocate multiple super blocks included in multiple name spaces (NS0, . . . , and NS4 of FIG. 19). However, if the number of super blocks (1201) of the first class, super blocks (1202) of the second class, or super blocks (1203) of the third class cannot be allocated to multiple name spaces (NS0, . . . , and NS4) in the same number, the processor (134) may unequally allocate multiple super blocks included in the multiple name spaces (NS0, . . . , and NS4).

The processor (134) may allocate one third-class super block (1203) included in the first name space (NS0 of FIG. 19) by exchanging it with one first-class super block (1201) included in the fifth name space (NS4 of FIG. 19). The processor (134) may allocate one second-class super block (1202) included in the third name space (NS2 of FIG. 19) by exchanging it with one first-class super block (1201) included in the fifth name space (NS4 of FIG. 19).

Accordingly, five first-class super blocks (1201), one second-class super block (1202), and two third-class super blocks (1203) may be allocated to the first name space (NS0 in FIG. 20). A second name space (NS1 in FIG. 20) may be allocated five first-class super blocks (1201), one second-class super block (1202), and two third-class super blocks (1203). A third namespace (NS2 in FIG. 20) may be allocated four first-class super blocks (1201), three second-class super blocks (1202), and one third-class super block (1203). A fourth namespace (NS3 in FIG. 20) may be allocated four first-class super blocks (1201), three second-class super blocks (1202), and one third-class super block (1203). The fifth namespace (NS4 in FIG. 20) may be allocated four first-class super blocks (1201), three second-class super blocks (1202), and one third-class super block (1203).

Multiple tenants, each of which is provided with the first and second virtual functions (VF0-VF1), may be provided with the same QoS. Multiple tenants, each of which is provided with the third to fifth virtual functions (VF2-VF4), may be provided with the same QoS. Multiple tenants each provided with the third to fifth virtual functions (VF2-VF4) may be provided with a higher QoS compared to multiple tenants each provided with the first to second virtual functions (VF0-VF1). Multiple tenants may be determined to be provided with the third to fifth virtual functions (V20-VF4) based on information about the tenant priorities.

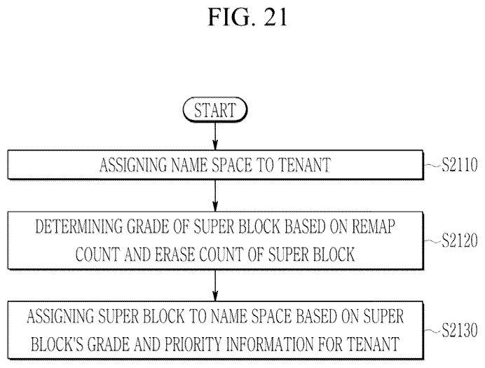

FIG. 21 illustrates a process in which a storage device provides multiple super blocks to multiple tenants.

In step (S2110), the storage device (120 of FIG. 1) may allocate multiple name spaces (NS0-NSj of FIG. 2) to multiple tenants. Multiple name spaces (NS0-NSj) may be allocated to multiple super blocks (SB0-SB7 in FIG. 4) contained in multiple non-volatile memories (1401-1, 1401-2, . . . , and 1401-3). Multiple super blocks (SB0-SB7) may each contain multiple logic blocks (LBs) sharing the same word lines. A storage device (120) may allocate multiple super blocks (SB0-SB7) to multiple tenants.

In operation (S2120), the storage device (120) may determine the grade (GRADE) of the super block based on the remapping count (GRC of FIG. 11) and the erase count (EC of FIG. 11) of multiple super blocks (SB0-SB7). The remapping count (GRC) of the plurality of super blocks (SB0-SB7) may be determined based on the number of times one memory block among the memory blocks included in each of the plurality of super blocks (SB0-SB7) including the plurality of memory blocks on the plurality of dies is mapped to another memory block.

According to one embodiment, the number of remapping operations (GRC) of the plurality of super blocks (SB0-SB7) may include the number of times a bad block, which is not capable of a data read operation, included in a first die among the plurality of dies is mapped to a normal block included in a second die, which is connected to a same channel connected to the first die and the second die is different from the first die.

According to one embodiment, the remapping count (GRC) of a super block (SB0-SB7) may include the number of times a bad block in a first plane included in a first die among a plurality of dies, which is not capable of data read operation, is mapped to a normal block in a second plane different from the first plane included in the first die.

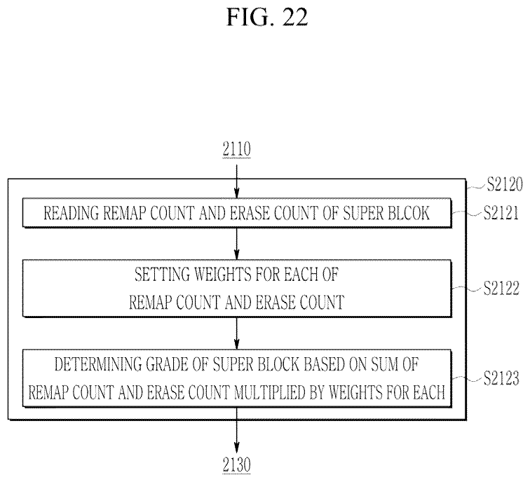

FIG. 22 illustrates the process by which a storage device determines the grade of a super block.

In operation (S2121), the storage device (120 of FIG. 1) may read the remapping count (GRC) and the erase count (EC) of multiple super blocks (SB0-SB7) from the grade hash table (1321 of FIG. 7). The grade hash table (1321) may include the grade of the super block (GRADE), the index of the super block (INDEX), the global remapping count (GRC) of the super block, and the erase count (EC) of the super block.

In operation (S2122), the storage device (120) may set weights for each of the remapping count (GRC) and the erase count (EC). The weight for the remapping count (GRC) of multiple super blocks (SB0-SB7) may be set higher than the weight for the erase count (EC) of multiple super blocks (SB0-SB7). For example, the storage device (120) may set a weight of 0.8 for the global remapping count (GRC) of the super block (SB0-SB7) and a weight of 0.2 for the erase count (EC).

In operation (S2123), the storage device (120) may determine the grade (GRADE) of multiple super blocks (SB0-SB7) based on the sum of the values obtained by multiplying the weights by the remapping count (GRC) and the erase count (EC), respectively. The storage device (120) may calculate a grade index (GRADE INDEX) of a super block based on the set weight, and determine a percentile of the corresponding super block (SB0-SB7) among all super blocks (SB0-SB7) using the grade index (GRADE INDEX). The storage device (120) may determine the grade (GRADE) based on the percentile of the corresponding super block (SB0-SB7).

For example, the storage device (120) may determine a level 1 if the percentile of the corresponding super block (SB0-SB7) is greater than 0 and less than or equal to 33, a level 2 if it is greater than 33 and less than or equal to 66, and a level 3 if it is greater than 66 and less than or equal to 100.

Referring again to FIG. 21, at operation (S2130), the storage device (120) may allocate multiple super blocks (SB0-SB7) to multiple name spaces (NS0-NSj) based on the grade (GRADE) of the multiple super blocks (SB0-SB7) and the priority information about the tenant.

According to one embodiment, when the storage device (120) determines that the priorities of the plurality of tenants are the same based on the priority information about the plurality of tenants, the storage device (120) may allocate the plurality of super blocks (SB0-SB7) to the plurality of name spaces (NS0-NSj) such that the number of super blocks (SB0-SB7) of the same grade (GRADE) included in each of the plurality of name spaces (NS0-NSj) is substantially the same for each of the plurality of name spaces (NS0-NSj).

According to one embodiment, when the storage device (120) determines that the priorities of the plurality of tenants are different based on the priority information about the plurality of tenants, the storage device (120) may allocate the plurality of super blocks (SB0-SB7) to the plurality of name spaces (NS0-NSj) such that the number of super blocks (SB0-SB7) of the same grade (GRADE) included in each of the plurality of name spaces (NS0-NSj) is different for each of the plurality of name spaces (NS0-NSj). For example, if the priority of a first tenant among a plurality of tenants is higher than that of other tenants, the storage device (120) may allocate a plurality of super blocks (SB0-SB7) to the plurality of name spaces (NS0-NSj) such that the number of low-rank super blocks (SB0-SB7) assigned to the first name space (NS0) assigned to the first tenant among the plurality of name spaces (NS0-NSj) is greater than the number of super blocks (SB0-SB7) assigned to the remaining name spaces (NS1-NSj) among the plurality of name spaces (NS0-NSj).

When garbage collection, wear leveling, or read reclaim is performed on a plurality of memory blocks, the storage device (120) may re-determine the grades (GRADE) of the plurality of super blocks (SB0-SB7) based on the remapping count (GRC) and the erase count (EC). For example, the storage device (120) may determine whether a physical block corresponding to a logical block (LB in FIG. 4) has changed. The physical block corresponding to a logic block (LB) may change location due to reasons such as garbage collection, read reclaim, and wear leveling.

In the case of garbage collection, the location may change between the physical block corresponding to the logic block (LB) where invalid data is stored and the physical block corresponding to the logic block (LB) that will store valid data. In the case of wear leveling, the location between the physical block of a frequently used logic block (LB) and the physical block of an infrequently used logic block (LB) may be changed so that the physical block corresponding to the infrequently used logic block (LB) may be used more. In the case of read reclaim, the location may change between the physical block corresponding to the logic block (LB) that repeatedly read a specific page and the physical block corresponding to the new logic block (LB). It may affect the global remap count or erase count of a superblock based on garbage collection, read reclaim, or wear leveling operations.

The storage device (120) may update the global remapping count (GRC) and erase count (EC) of multiple super blocks (SB0-SB7). The global remapping count (GRC) may increase when data stored in a bad block (1451 in FIG. 12) is mapped to a second mapping block (1454 in FIG. 13), resulting in duplicate accesses to the same plane. The erase count (EC) of a super block may be increased when an erase operation of data is performed on any one of multiple logical blocks included in the super block.

The storage device (120) may update the grade (GRADE) of the super block. When garbage collection, read reclaim, or wear leveling is performed on multiple physical blocks, the storage controller (130) may re-determine the grades (GRADE) for multiple super blocks based on the global remapping count (GRC) and the erase count (EC). The storage device (120) may rearrange the plurality of super blocks (SB0-SB7) using the updated ranks of the plurality of super blocks. The storage device (120) may rearrange multiple super blocks (SB0-SB7) included in multiple name spaces (NS0-NSj) based on priority information of multiple tenants. A storage device (120) may provide multiple rearranged super blocks to multiple tenants.

In another embodiment, the storage device (120) may provide multiple super blocks whose ranks have not changed to multiple tenants if there is no change in the location of the physical blocks corresponding to the logical blocks (LBs).

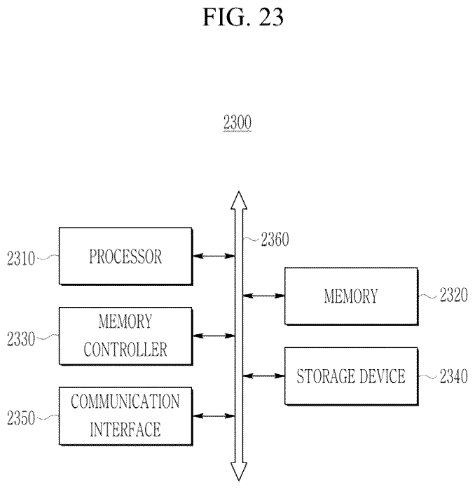

FIG. 23 illustrates a computer device according to one embodiment.

Referring to FIG. 23, a computing device (2300) may include a processor (2310), a memory (2320), a memory controller (2330), a storage device (2340), a communication interface (2350), and a bus (2360). The computing device (2300) may further include other general-purpose components.

The processor (2310) may be configured to control the overall operation of each component of the computing device (2300). The processor (2310) may be implemented as at least one of various processing units, such as a central processing unit, an application processor (AP), and a graphic processing unit (GPU).

The processor (2310) may create multiple name spaces (NS0, NS1, NS2, . . . , and NSj in FIG. 2) in one physical space (PS0 in FIG. 2) by using virtualization technology. The processor (2310) may arrange a plurality of super blocks included in a plurality of name spaces based on priority information about a plurality of tenants.

Memory (2320) may be configured to store various data and commands. The memory (2320) may be implemented as a memory device described with reference to FIGS. 1 to 22. The memory controller (2330) controls the transfer of data or commands to and from the memory (2320). In some embodiments, the memory controller (2330) may be provided as a separate chip from the processor (2310). In some embodiments, the memory controller (2330) may be provided as an internal component of the processor (2310).

The storage device (2340) may be configured to, non-temporarily, store programs and data. In some embodiments, the storage device (2340) may be implemented as non-volatile memory. The communication interface (2350) supports wired and wireless Internet communication of the computing device (2300). Additionally, the communication interface (2350) may support various communication methods other than Internet communication. The bus (2360) provides communication capabilities between components of the computing device (2300). The bus (2360) may include at least one type of bus (2360) depending on the communication protocol between the components.

Although the embodiments of the present disclosure have been described in detail above, the scope of the present disclosure is not limited to the above embodiments, and various modifications and improvements made by those skilled in the art using the basic concept of the present disclosure defined in the following claims also fall within the scope of the present disclosure.

What is claimed is:

1. A storage device comprising:
a plurality of non-volatile memories comprising a plurality of super blocks, each of which comprises a plurality of memory blocks on a plurality of dies, and
a storage controller configured to:
allocate a plurality of name spaces to a plurality of tenants,
determine grades of the plurality of super blocks based on a remapping count of remapping one memory block to another memory block in each of the plurality of super blocks, and an erase count of an erase operation with respect to the plurality of memory blocks, and
allocate the plurality of super blocks to the plurality of name spaces, based on the grades of the plurality of super blocks and priority information about the plurality of tenants.

2. The storage device of claim 1, wherein the remapping count comprises a number of times that a bad block in a first die is mapped to a normal block in a second die,
wherein the storage controller is impossible to read data from the bad block, and
wherein the second die is connected to a same channel connected to the first die and the second die is different from the first die.

3. The storage device of claim 1, wherein the remapping count comprises a number of times that a bad block in a first plane of a first die is mapped to a normal block in a second plane of the first die that is different from the first plane, and
wherein the storage controller is impossible to perform a data read operation on the bad block in the first plane of the first die.

4. The storage device of claim 1, wherein the storage controller comprises a grade hash table configured to store information on a remapping count with respect to the plurality of super blocks, an erase count with respect to the plurality of super blocks, and the grades of the plurality of super blocks, and
wherein the storage device further comprises a grade determination circuit comprising a circuit configured to:
read the remapping count of the plurality of super blocks and the erase count of the plurality of super blocks from the grade hash table,
set a first weight for the remapping count and a second weight for the erase count, and
determine the grades of the plurality of super blocks, based on a sum of values obtained by multiplying the remapping count by the first weight and multiplying the erase count by the second weight.

5. The storage device of claim 4, wherein the first weight for the remapping count of the plurality of super blocks is higher than the second weight for the erase count of the plurality of super blocks.

6. The storage device of claim 1, wherein the storage controller is further configured to determine a rank of the plurality of super blocks based on the remapping count and the erase count when garbage collection, wear leveling, or read reclaim is performed on the plurality of memory blocks.

7. The storage device of claim 1, wherein the storage controller is further configured to:
determine that priorities of the plurality of tenants are the same based on the priority information about the plurality of tenants; and
allocate the plurality of super blocks to the plurality of name spaces so that respective numbers of super blocks of a same grade in the plurality of name spaces is substantially the same.

8. The storage device of claim 1, wherein the storage controller is further configured to:
determine that priorities of the plurality of tenants are different based on the priority information about the plurality of tenants, and
allocate the plurality of super blocks to the plurality of name spaces so that respective numbers of super blocks of a same grade in each of the plurality of name spaces are different.

9. The storage device of claim 8, wherein, based on determining that a priority of a first tenant among the plurality of tenants is higher than that of other tenants, the storage controller is configured to allocate the plurality of super blocks to the plurality of name spaces such that a number of low-grade super blocks assigned to a first name space assigned to the first tenant among the plurality of name spaces is greater than a number of super blocks assigned to remaining name spaces among the plurality of name spaces, and
wherein the low-grade super blocks have lower latency than high-grade super blocks.

10. A storage system comprising:
a host device configured to manage a plurality of tenants and provide priority information about the plurality of tenants, and
a storage device configured to:
determine grades of a plurality of super blocks based on a plurality of parameters of memory blocks in a plurality of super blocks, and
allocate the plurality of super blocks to a plurality of name spaces allocated to the plurality of tenants, based on the grades of the plurality of super blocks and the priority information.

11. The storage system of claim 10, wherein the plurality of parameters comprise:
a remapping count of remapping one of the memory blocks to another memory block in each of the plurality of super blocks, and
an erase count with respect to the memory blocks.

12. A method of operating a storage device, the method comprising:
assigning a plurality of name spaces to a plurality of tenants, respectively;
determining grades of a plurality of super blocks, based on a remapping count in which one of memory blocks included in each of the plurality of super blocks including a plurality of memory blocks on a plurality of dies is mapped to another memory block and an erase count of an erase operation with respect to the plurality of memory blocks; and
allocating the plurality of super blocks to the plurality of name spaces based on ranks of the plurality of super blocks and priority information about the plurality of tenants.

13. The method of claim 12, wherein the remapping count comprises a number of times that a bad block in a first die among the plurality of dies is mapped to a normal block in a second die connected to a same channel connected to the first die, and
wherein the second die is different from the first die.

14. The method of claim 12, wherein the remapping count comprises a number of times that a bad block in a first die among the plurality of dies is mapped to a normal block in a second plane,
wherein a data on the bad block in a first plane of the first die is impossible to be read, and
wherein the second plane is different from the first plane in the first die.

15. The method of claim 12, wherein the determining the grades of the plurality of super blocks, comprises:
leading the remapping count of the plurality of super blocks and the erase count of the plurality of super blocks;
setting a first weight for the remapping count and a second weight for the erase count; and
determining the grades of the plurality of super blocks, based on a sum of values obtained by multiplying the remapping count by the first weight and multiplying the erase count by the second weight.

16. The method of claim 15, wherein the first weight for the remapping count of the plurality of super blocks is higher than the second weight for the erase count of the plurality of super blocks.

17. The method of claim 12, further comprising determining the ranks of the plurality of super blocks, based on the remapping count and the erase count, when garbage collection, wear leveling, or read reclaim is performed on the plurality of memory blocks.

18. The method of claim 12, wherein the allocating the plurality of super blocks to the plurality of name spaces, comprises:
determining that priorities of the plurality of tenants are the same based on the priority information about the plurality of tenants; and
allocating a plurality of super blocks to the plurality of name spaces such that a number of super blocks of the same grade in each of the plurality of name spaces is substantially the same for each of the plurality of name spaces.

19. The method of claim 12, wherein the allocating the plurality of super blocks to the plurality of name spaces, comprises:
determining that priorities of the plurality of tenants are different based on the priority information about the plurality of tenants; and
allocating the plurality of super blocks to the plurality of name spaces such that a number of super blocks of the same grade in each of the plurality of name spaces is different for each of the plurality of name spaces.

20. The method of claim 19, wherein the allocating the plurality of super blocks to the plurality of name spaces, comprises allocating a plurality of super blocks to the plurality of name spaces such that a number of low-grade super blocks assigned to a first name space assigned to a first tenant among the plurality of name spaces is greater than the number of super blocks assigned to remaining name spaces among the plurality of name spaces, when a priority of the first tenant among the plurality of tenants is higher than that of other tenants.
